(19) United States
(12) Patent Application Publication
(10) Pub. No.: US 2025/0273245 A1
(43) Pub. Date: Aug. 28, 2025

(54) POST CAPTURE AUGMENTATION EFFECTS

(71) Applicant: Snap Inc., Santa Monica, CA (US)

(72) Inventors: Nathan Kenneth Boyd, Los Angeles, CA (US); Yuelin Cheng, Kirkland, WA (US); Bo Feng, Los Angeles, CA (US); Shouhan Gao, Beijing (CN); Yongwei Hu, Beijing (CN); Bo Huang, Renton, WA (US); Bertrand Saint-Preux, Hollywood, FL (US); Anbang Zhao, Seattle, WA (US)

(21) Appl. No.: 18/589,381

(22) Filed: Feb. 27, 2024

(51) Int. Cl. G11B 27/031; G06F 3/0488; G06T 13/80; G06V 40/16

(52) U.S. Cl. CPC G11B 27/031; G06F 3/0488; G06T 13/80; G06V 40/16

(57) ABSTRACT

A system and method for augmenting media data with augmentation effects after capture. An interaction system detects selection of media data from a user's media library. The interaction system determines the type of selection (tap or long press) and type of the media data (image or video). Based on these inputs, the platform generates augmented media data by applying an augmentation to the selected media data. For a tap selection of an image, the augmentation is applied to the image. For a tap selection of a video, the augmentation is applied to a frame of the video. For a long press on an image, the augmentation is animated on the image. For a long press on a video, the augmentation is animated and composited with the video. The user can select the augmentation from a carousel of options.

### TECHNICAL FIELD

The present disclosure relates generally to interaction systems and more particularly to providing interaction interfaces to users of an interaction system.

### BACKGROUND

Users access interaction systems to exchange user generated content with other users. In some instances, a user may want to generate user content using media previously captured by the user.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality.

FIG. 3A illustrates an augmentation method, according to some examples.

FIG. 3B a media library user interface and an augmentation user interface of an augmentation method, according to some examples.

FIG. 4 is an illustration of a footer tab user interface, according to some examples.

FIG. 5 is an illustration of a camera-style view augmentation user interface, according to some examples.

FIG. 6A illustrates a machine-learning pipeline, according to some examples.

FIG. 6B illustrates training and use of a machine-learning program, according to some examples.

FIG. 7 is a diagrammatic representation of a data structure as maintained in a database, according to some examples.

FIG. 8 is a diagrammatic representation of a message, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

### DETAILED DESCRIPTION

Interaction systems such as, but not limited to, interactive platforms, social media platforms, online gamming platforms, platforms providing virtual worlds, messaging application platforms, video conferencing platforms, and the like, may provide a way for users to interact with each other. Some interaction systems allow users to capture and share media such as photos, videos, and the like, with friends. An interaction system may provide augmentation effects in the form of filters or lenses that can be applied to photos or videos in real-time as they are captured. However, functionality of the interaction system is enhanced if the augmentation effects may be applied to media after it has already been captured and stored.

An interaction system in accordance with this disclosure allows users to apply augmentation effects to previously captured media data stored in a datastore. Example augmentations include, but are not limited to:
Filters (e.g., black and white, sepia, brightness/contrast adjustments, and the like)
Stickers (e.g., static images like emojis, icons, shapes)
Text overlays
Doodles (e.g., handwritten text or drawings)
Face filters (e.g., dog ears, crowns, facial hair, distortions, and the like)
Background changes
Visual effects (e.g., sparkles, lightning, lasers, and the like)
AR objects (e.g., 3D models placed in the scene)
Green screen effects
Slow motion or fast forward
Music/audio overlays
Voiceovers
Subtitles/captions
Animated text
Transitions between clips
Split screen or picture-in-picture
Blurring/censoring
Zooming/pan effects
Color pop (e.g., make certain colors stand out)
Memes
Stickers that move with faces or objects
Slofies (e.g., slow motion selfies)
Boomerangs (e.g., forward and backward clip loops)

The interaction system provides an option within a User Interface (UI) to add augmentation effects to existing user media data. Users can scroll through their stored media data and available augmentation effects to find their preferred combination. The interaction system enables users to visually augment and customize their pre-captured media data with interactive augmentation effects. This provides more creativity and personalization for users' existing media data.

In some examples, an interaction system detects a selection of selected media data from stored media data of a first user. The interaction system also detects a type of the selection and a type of the selected media data. The interaction system generates augmented media data by applying an augmentation to the selected media data based on the type of the selection and the type of the selected media data. The interaction system provides the augmented media data to a second user.

In some examples, the type of the selection is a tap, the type of the selected media data is image data, and generating the augmented media data comprises applying the augmentation to the selected media data to generate augmented image data as the augmented media data.

In some examples, the type of the selection is a tap, the type of the selected media data is video data, and generating the augmented media data comprises applying the augmentation to a frame of the video data to generate augmented image data as the augmented media data.

In some examples, the type of the selection is a long press, the type of the selected media data is image data, and generating the augmented media data comprises applying the augmentation as an animation to the image data to generate animated image data as the augmented media data.

In some examples, the type of the selection is a long press, the type of the selected media data is video data, and generating the augmented media data comprises compositing the augmentation as an animation with the video data to generate augmented video data as the augmented media data.

In some examples, the interaction system receives a selection of the augmentation from a carousel of available augmentations.

In some examples, the interaction system recognizes a face in the selected media data and positions the augmentation on the face in the selected media data.

Other technical features may be readily apparent to one skilled in the art from the following figures, descriptions, and claims.

### Networked Computing Environment

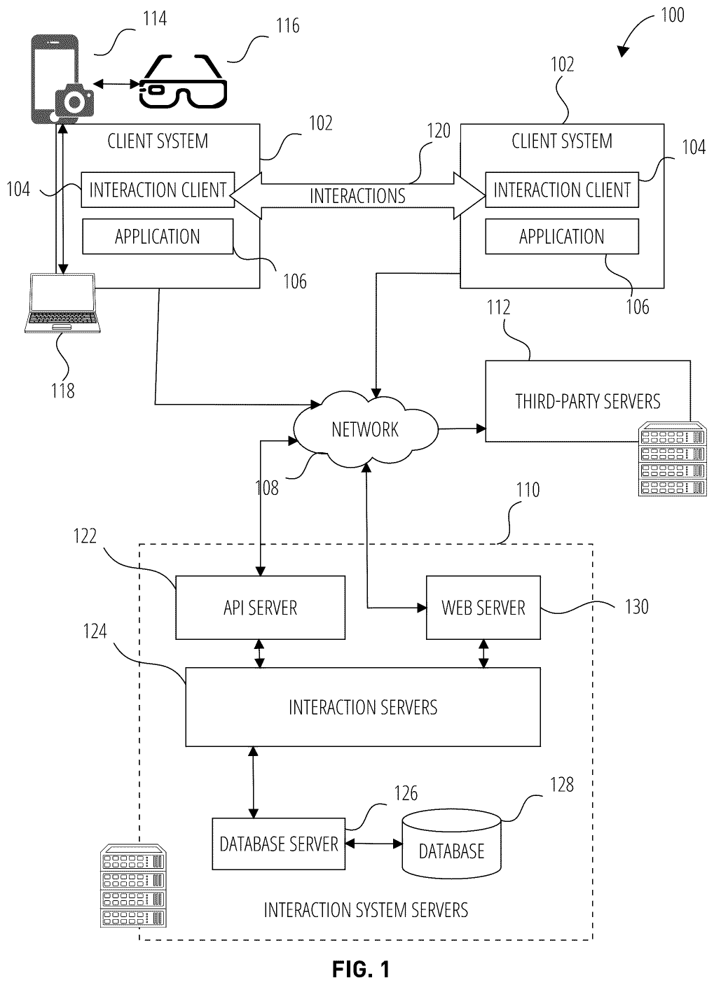

FIG. 1 is a block diagram showing an example interaction system 100 of an interaction system for facilitating interactions (e.g., exchanging text messages, conducting text audio and video calls, or playing games) over a network. The interaction system 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other client systems 102), an interaction system servers 110 and third-party servers 112). An interaction client 104 can also communicate with locally hosted applications 106 using Applications Program Interfaces (APIs).

Each client system 102 may include multiple user devices, such as a mobile client device 114, head-wearable client device 116, and a computer client device 118 that are communicatively connected to exchange data and messages.

An interaction client 104 interacts with other interaction clients 104 and with the interaction system servers 110 via the network 108. The data exchanged between the interaction clients 104 (e.g., interactions 120) and between the interaction clients 104 and the interaction system servers 110 includes functions (e.g., commands to invoke functions) and payload data (e.g., text, audio, video, or other multimedia content).

The interaction system servers 110 provides server-side functionality via the network 108 to the interaction clients 104. While certain functions of the interaction system 100 are described herein as being performed by either an interaction client 104 or by the interaction system servers 110, the location of certain functionality either within the interaction client 104 or the interaction system servers 110 may be a design choice. For example, it may be technically preferable to initially deploy particular technology and functionality within the interaction system servers 110 but to later migrate this technology and functionality to the interaction client 104 where a client system 102 has sufficient processing capacity.

The interaction system servers 110 supports various services and operations that are provided to the interaction clients 104. Such operations include transmitting data to, receiving data from, and processing data generated by the interaction clients 104. This data may include message content, client device information, geolocation information, media data augmentation and overlays, message media data persistence conditions, interaction system information, and live event information. Data exchanges within the interaction system 100 are invoked and controlled through functions available via user interfaces (UIs) of the interaction clients 104.

Turning now specifically to the interaction system servers 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the client systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a client system 102; the retrieval of messages and content; the addition and deletion of entities (e.g., friends) to an entity graph (e.g., a social graph); the location of friends within a social graph; and opening an application event (e.g., relating to the interaction client 104).

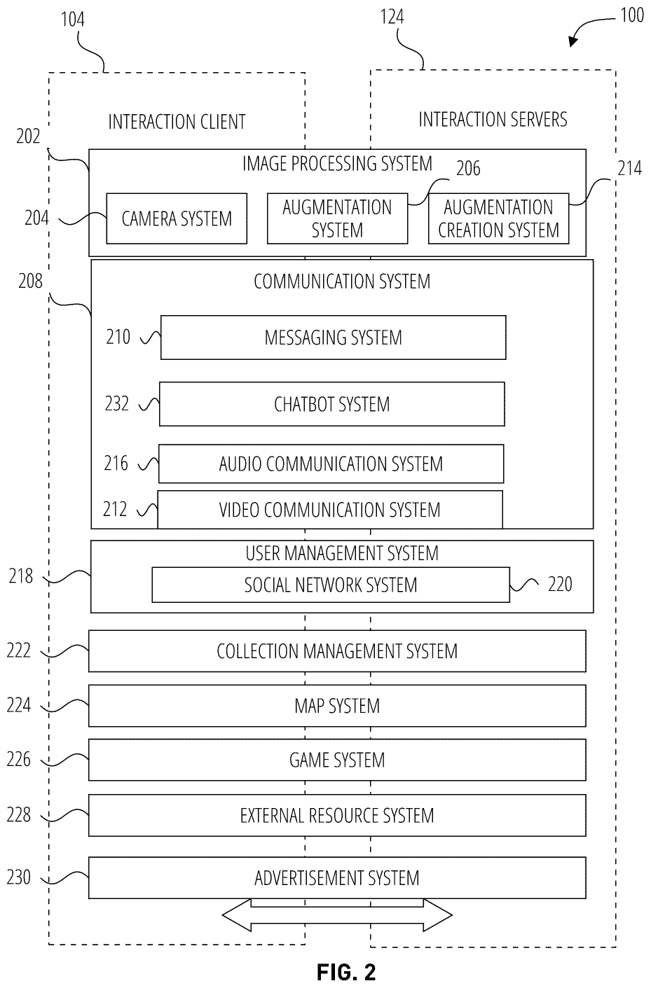

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the client system 102 (e.g., a “native app”), or a small-scale version of the application (e.g., an “applet”) that is hosted on the client system 102 or remote of the client system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the client system 102 can be launched independently of and separately from the interaction client 104, such as by selecting an icon corresponding to the application 106 on a home screen of the client system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the client system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the client system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, using a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., augment or otherwise modify or edit) media data associated with a message.

A camera system 204 includes control software (e.g., in a camera application) that interacts with and controls hardware camera hardware (e.g., directly or via operating system controls) of the client system 102 to modify and augment real-time images captured and displayed via the interaction client 104.

The augmentation system 206 provides functions related to the generation and publishing of augmentations (e.g., media overlays) for images captured in real-time by cameras of the client system 102 or retrieved from memory of the client system 102. For example, the augmentation system 206 operatively selects, presents, and displays media overlays (e.g., an image filter or an image lens) to the interaction client 104 for the augmentation of real-time images received via the camera system 204 or stored images retrieved from memory of a client system 102. These augmentations are selected by the augmentation system 206 and presented to a user of an interaction client 104, using a number of inputs and data, such as for example:
Geolocation of the client system 102; and
interaction system information of the user of the client system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media data item (e.g., a photo or video) at client system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the client system 102 or a video stream produced by the client system 102. In some examples, the media overlay may be a location overlay (e.g., Venice beach), a name of a live event, or a name of a merchant overlay (e.g., Beach Coffee House). In further examples, the image processing system 202 uses the geolocation of the client system 102 to identify a media overlay that includes the name of a merchant at the geolocation of the client system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, a chatbot system 232, an audio communication system 216, and a video communication system 212. The messaging system 210 is responsible for enforcing the temporary or time-limited access to content by the interaction clients 104. The messaging system 210 incorporates multiple timers within an ephemeral timer system (not shown) that, using duration and display parameters associated with a message or collection of messages (e.g., a story), selectively enable access (e.g., for presentation and display) to messages and associated content via the interaction client 104. Further details regarding the operation of the ephemeral timer system are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104. The chatbot system 232 is responsible for generating responses to prompts received from a user and communicating a response to the prompt.

A user management system 218 is operationally responsible for the management of user data and profiles, and includes a social network system 220 that maintains interaction system information regarding relationships between users of the interaction system 100.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system 224 provides various geographic location functions and supports the presentation of map-based media data and messages by the interaction client 104. For example, the map system 224 enables the display of user icons or avatars (e.g., stored in profile data 702) on a map to indicate a current or past location of “friends” of a user, as well as media data (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 226 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 228 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction system servers 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A Web ViewJavaScriptBridge running on a client system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 230 operationally enables the purchasing of advertisements by third parties for presentation to end-users via the interaction clients 104 and also handles the delivery and presentation of these advertisements.

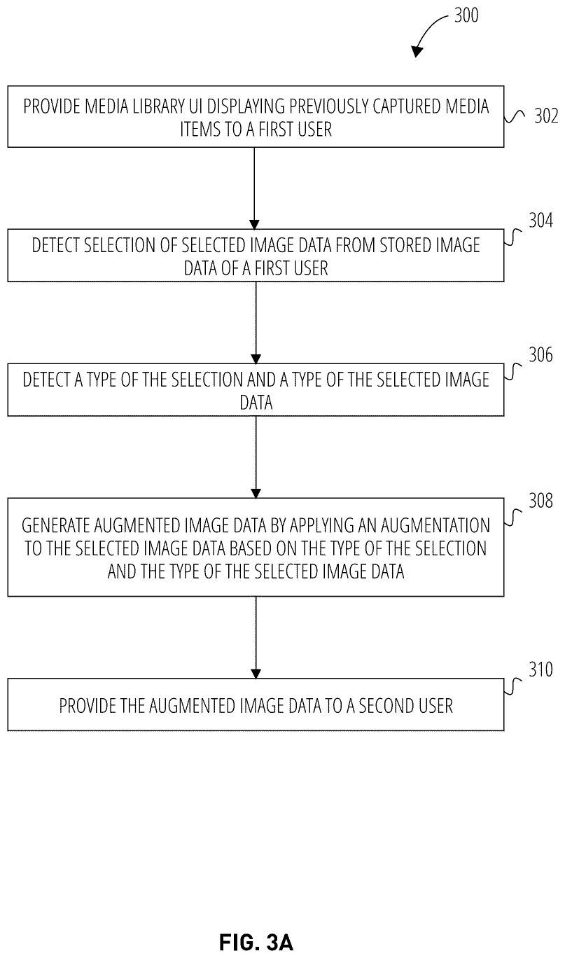

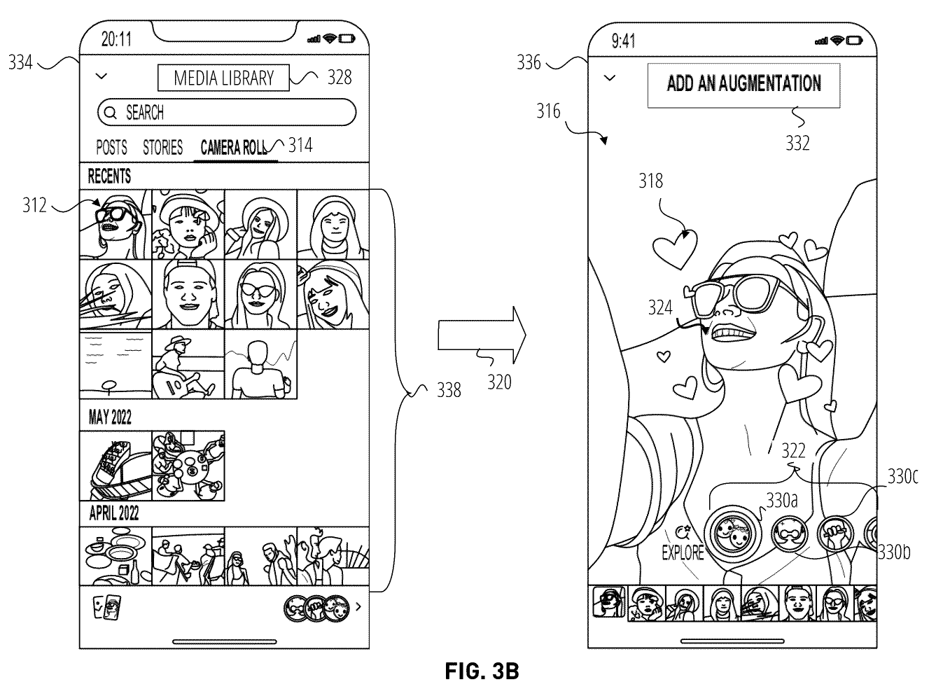

FIG. 3A illustrates an example augmentation method 300 of an interaction system 100 (of FIG. 1) and FIG. 3B illustrates a media library UI 334 and an augmentation UI 336 of an augmentation method, according to some examples. An interaction system 100 uses the augmentation method 300 to augment media data that was previously captured by a user. In some examples, the media library UI 334 and the augmentation UI 336 are provided to a user on a client device of a user such as, but not limited to, mobile client device 114, computer client device 118, head-wearable client device 116, or the like (each of FIG. 1).

Although the example augmentation method 300 depicts a particular sequence of operations, the sequence may be altered without departing from the scope of the present disclosure. For example, some of the operations depicted may be performed in parallel or in a different sequence that does not materially affect the function of the augmentation method 300. In other examples, different components of an interaction system 100 that implements the augmentation method 300 may perform functions at substantially the same time or in a specific sequence.

In operation 302, the interaction system 100 provides a media library UI displaying previously captured media data of one or more media items of a user. For example, the interaction system 100 generates a media library UI 334 comprising a set of selectable images 338 representing media data, such as still images and videos, that were previously captured by the user and stored on the interaction system 100 in a personal media library 328. The media library UI 334 of the media library 328 allows a user to retrieve media data through several modes, such as by accessing the camera roll 314 comprising media data of still photos and videos. The interaction system 100 generates the media library UI 334 and provides the media library UI 334 to a user via as a display on a client device of the user such as, but not limited to, a head-wearable client device 116, a mobile client device 114, a computer client device 118, (all of FIG. 1) or the like.

In operation 304, the interaction system 100 detects selection of selected media data, such as media data 312 from stored media data of a user. For example, when the user uses their client device to select media data 312 from their personal media library 328 to augment, the interaction system 100 detects this selection. The selected media data comprises media data 312 that will be augmented by applying an augmentation to the media data 312.

In operation 306, the interaction system 100 detects a type of the selection and a type of the selected media data. For example, the interaction system 100 detects if the user selection is a tap or a long press on the selected media data. The interaction system 100 also detects if the selected media data is image data or video data. By detecting the type of user selection and the type of selected media data, the interaction system can determine an appropriate augmentation to apply.

In some examples, the interaction system 100 differentiates between a tap type of selection and a long press type selection by tracking the duration of touch events on a device screen of the client device of the user. By measuring the time from when a touch starts to when it ends, the interaction system 100 can compare the duration to the defined threshold and categorize the input appropriately as either a brief tap type selection or a sustained long press type of selection. For example, to detect a tap type selection, the interaction system 100 monitors touch events on a device screen of the client device of the user. When a brief touch event occurs that lasts less than a set threshold duration, the interaction system 100 classifies this as a tap type selection. To detect a long press type selection, the interaction system 100 monitors touch events on the device screen. When a sustained touch event occurs that exceeds the threshold duration, the interaction system 100 classifies this as a long press type selection. In some examples, the set threshold duration is 500 milliseconds although it is to be understood that shorter or longer threshold durations may be used.

In some examples, the client device of the user makes the determination of the type of selection, such as between a tap type selection or a long press type selection, and communicates the determination to the interaction system 100.

In some examples, a user input modality having different types of selection modes is used by the interaction system 100 to determine a selection of media data such as, but not limited to, one or more swiping gesture selections made by the user on a touchscreen, one or more button or key presses made by the user on the client device of the user, one or more voice commands issued by the user to their client device, one or more non-contact gestures detected by the client device of the user, one or more physical movements of the client device by the user, and the like.

In operation 308, the interaction system 100 generates 320 augmented media data 316 by applying an augmentation 318 to the selected media data using the type of the selection and the type of the selected media data. The interaction system 100 provides the augmented media data 316 in an augmentation UI 336 displayed on the client device of the user. For example, if the selection was a tap and the selected media data was media data of a still image, the interaction system 100 applies the augmentation as a static overlay to generate augmented image data comprising the augmented media data 316. If the selection was a long press and the selected media data was video data, the interaction system 100 applies the augmentation as an animated overlay composited with the video data to generate augmented video data comprising the augmented media data 316. By applying the appropriate augmentation based on selection type and media data type, the interaction system can generate tailored augmented media data 316.

In operation 310, the interaction system 100 provides the augmented media data to another user of the interaction system 100. For example, after generating the augmented media data 316 by applying an augmentation 318 to the selected media data, the interaction system 100 facilitates sharing the augmented media data 316 with other users of the interaction system 100. In some examples, the interaction system 100 allows the first user who selected the media data to share the augmented media data 316 as interaction system content in chats stories, and the like. When the augmented media data 316 is shared, the other user who is connected to the first user on the interaction system 100 can view the augmented media data 316.

In some examples, the interaction system 100 detects that the type of the selection is a tap and the type of the selected media data is image data. In response, the interaction system generates 320 the augmented media data 316 by applying the augmentation 318 to the selected media data 312 to create the augmented media data 316. For example, if the user simply taps to select media data 312 of a still photo from their media library 328, the interaction system 100 detects this as a tap selection of image data as the selected media data. To augment the image data of the still photo, the platform overlays the selected augmentation 318 onto the image data as a static media overlay, without any animation. This results in augmented image data as the augmented media data 316 with the augmentation layered over the original image data of the still photo.

In some examples, the interaction system 100 detects that the type of the selection is a tap and the type of the selected media data is video data. In response, the interaction system generates the augmented media data 316 by applying the augmentation 318 to a frame of the video data to create augmented image data as done for a still photo as described above. For example, if the user taps to select a video from their media library, the interaction system 100 recognizes this as a tap selection of video data. To augment the video data, the interaction system 100 extracts a single frame from the video data and overlays the selected augmentation 318 as a static overlay on that frame, without any animation. This results in augmented image data as the augmented media data 316 with the augmentation 318 applied to a representative frame of the selected video data. In some examples, the interaction system 100 prompts a user for a selection of a frame of the video data to be augmented. In some examples, the interaction system 100 selects a default frame of the video data. In some examples, the interaction system 100 randomly selects a frame of the video data to augment. In some examples, the detects a face in the video data and selects a frame of the video data comprising the face.

In some examples, the interaction system 100 detects that the type of the selection is a long press, and the type of the selected media data is image data. In response, the interaction system 100 generates 320 the augmented media data 316 by applying the augmentation 318 as an animation to the image data to create animated augmented media data. For example, if the user long presses to select image data of a still photo, the interaction system 100 recognizes this as a long press selection of image data. To augment the image data, the platform overlays the selected animated augmentation 318 that moves over time onto the image data. This results in the augmented media data 316 being animated image data that has an animated augmentation 318 applied to the image data of the static photo.

In some examples, the interaction system 100 detects that the type of the selection is a long press, and the type of the selected media data is video data. In response, the interaction system 100 generates 320 the augmented media data 316 by compositing the augmentation 318 as an animation with the video data to generate augmented video data as the augmented media data 316. For example, if the user long presses to select a video, the interaction system 100 recognizes this as a long press selection of video data of the video. To augment the video data, the interaction system 100 composites the augmentation 318 with frames of the selected video data. This results in augmented video data being generated as the augmented media data 316 that has the animated augmentation 318 composited with video frames of the video data.

In some examples, the interaction system 100 receives a selection of the augmentation 318 from a carousel 322 of available augmentations, such as selectable augmentation 330a, selectable augmentation 330b, and selectable augmentation 330c. For example, the interaction system 100 provides a carousel 322 UI that displays available augmentations 330a, 330b, and 330c for the user to choose from. The carousel 322 may include various augmentations such as, but not limited to: filters, stickers, text overlays, doodles, face filters, background changes, visual effects, extended reality objects, green screen effects, slow motion or fast forward, music/audio overlays, voiceovers, subtitles/captions, animated text, transitions between clips, split screen or picture-in-picture, blurring/censoring, zooming/pan effects, color pop, memes, stickers that move with faces or objects, slofies, boomerangs, and the like. When the user selects a specific augmentation from the carousel 322, the interaction system 100 detects this selection as input for which augmentation to apply to the selected media data. This allows the user to choose the desired augmentation they want to add to their media data. In some examples, the interaction system 100 uses a default augmentation to augment the selected media data.

In some examples, the interaction system 100 recognizes a face 324 in the selected media data and positions the augmentation 318 on the face 324 in the selected media data. For example, when the selected media data contains a person's face, the interaction system 100 utilizes face recognition methodologies to identify the location of the face within the selected media data. The interaction system 100 intelligently positions the selected augmentation 318, such as an animated mask or glasses, over the recognized face 324. In response to detecting a face in the selected media data, the interaction system 100 determines the location of the face within an image or a video frame such as by identifying coordinates of the face in a bounding box or the like. This results in the augmentation 318 being programmatically aligned and tracked to the appropriate area of the augmented media data 316 such that the augmentation 318 is dynamically positioned to augment the face 324 specifically versus just generically overlaying an entire image.

In some examples, the interaction system 100 uses image recognition methodologies to detect faces in media data such as, but not limited to: analyzing facial features like eyes, nose, and mouth and their relationships; skin texture analysis that looks at patterns in skin texture to identify faces; and template matching that matches face images to predefined face templates.

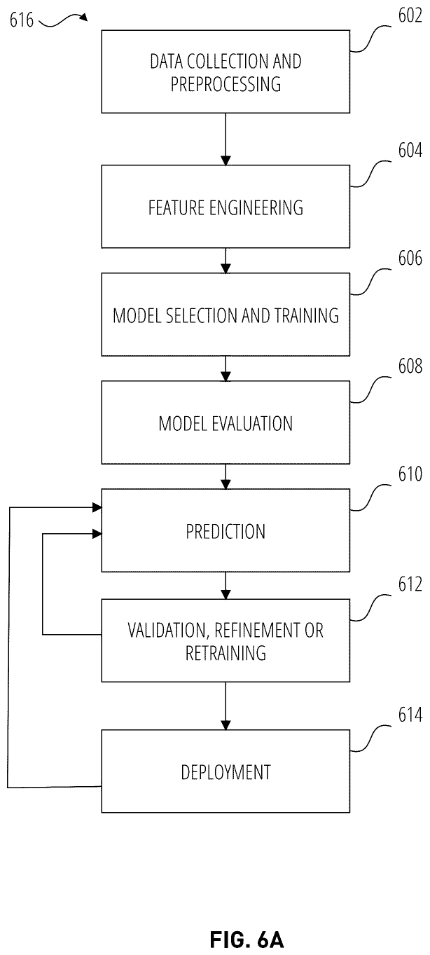

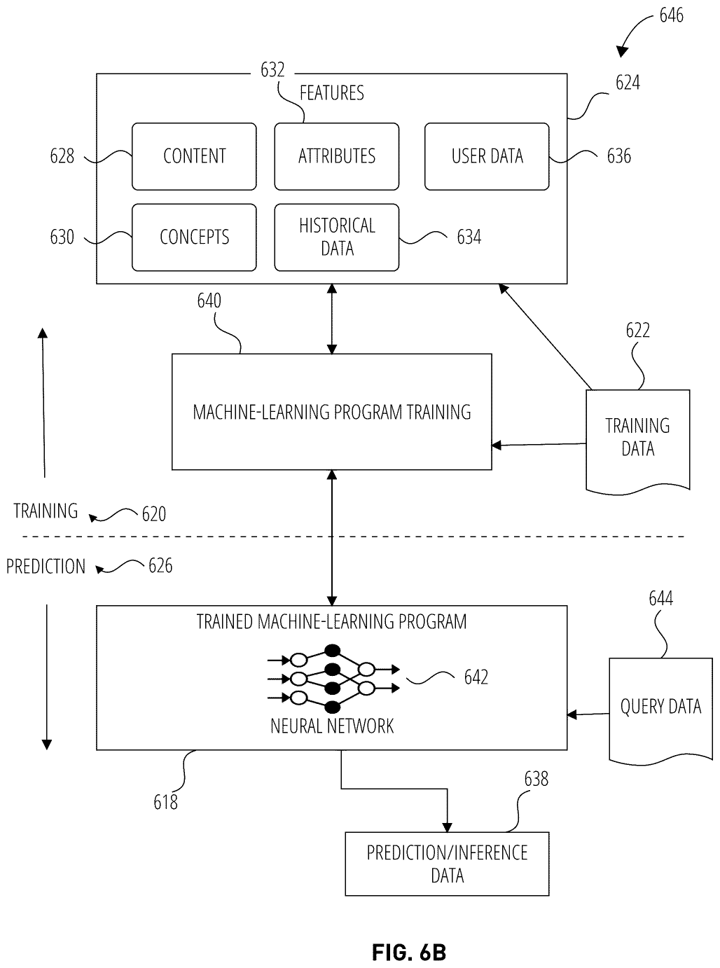

In some examples, the interaction system 100 uses AI methodologies and a trained model to detect faces in the selected image data as more fully described in reference to FIG. 6A and FIG. 6B.

In some examples, for media data that has already been edited by the user, the interaction system 100 flattens overlays before passing the base asset to an augmentation view. When exiting, the original media data is restored so no edits are lost.

In some examples, the interaction system 100 provides an option to a user for saving augmented versions of media data and as new media data in the media library 328, rather than overwriting original media data.

In some examples, the interaction system 100 displays a tooltip the first time a user encounters an augmentation UI entry point icon. The tooltip text prompts the user to “Add an Augmentation” 332. In some examples, the interaction system 100 dismisses the tooltip permanently if the user taps the entry point icon to launch the augmentation UI. In some examples, the interaction system 100 permanently dismisses the tooltip if the interaction system 100 has presented the tooltip across a specified number of separate memory gallery sessions. Showing the tooltip once per session may allow new feature discovery without being repetitive. Dismissing the tooltip after the user understands the feature may reduce clutter on subsequent views. The temporary tooltip provides helpful onboarding when the icon first appears.

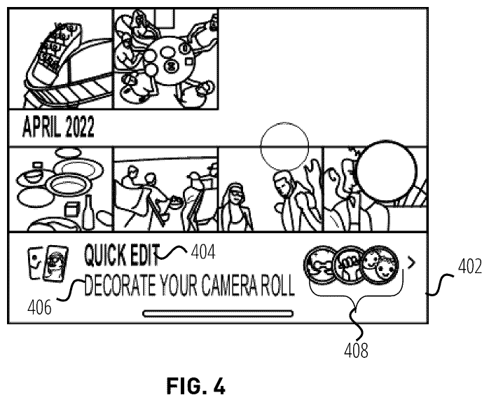

FIG. 4 is an illustration of a footer tab UI, according to some examples. An interaction system 100 (of FIG. 1) provides an entry point to an augmentation UI feature in a camera roll tab footer 402. The interaction system 100 displays the tab footer 402 at the bottom of a camera roll tab as an entry point. The banner contains a headline prompting “QUICK EDIT” 404 and a subheading explaining that a user can “Decorate your Camera Roll” 406 with augmentations 408.

In some examples, the interaction system 100 hides the tab footer 402 when the user scrolls down, the interaction system 100 re-displays the tab footer 402 when the user starts scrolling back up. This allows persistent access to the feature regardless of vertical scroll position.

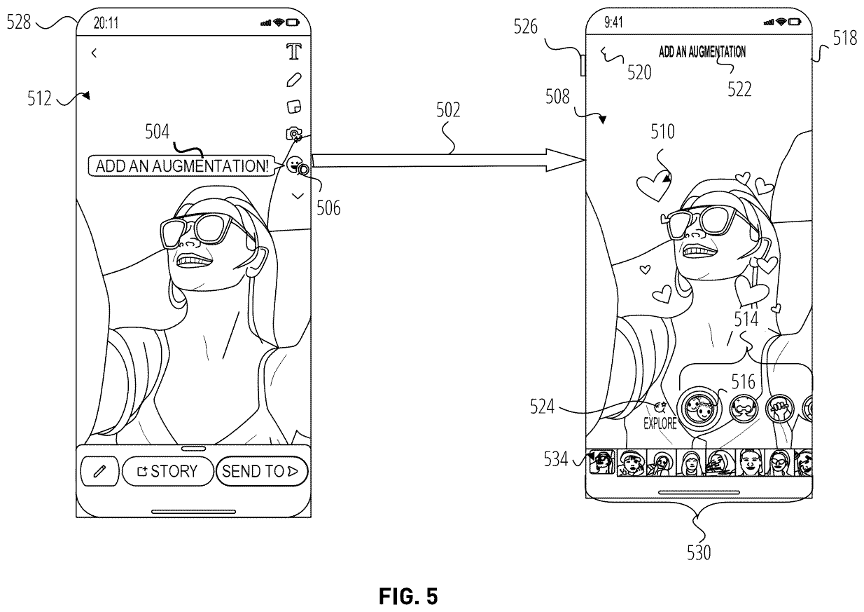

FIG. 5 is an illustration of a camera-style view augmentation UI 518, according to some examples. An interaction system 100 (of FIG. 1) provides a media gallery UI 528 to a user via a user's client device, such as, but not limited to, mobile client device 114, head-wearable client device 116, computer client device 118, and the like (all of FIG. 1). The user uses the media gallery UI 528 as an entry point into a camera-style view augmentation UI 518 provided to the user by the interaction system 100 via the client device.

The interaction system 100 displays a context-specific call-to-action message 504 when displaying selected media data 512 in the media gallery UI 528. In some examples, the call-to-action message 504 is associated with a selectable icon 506. In response to the interaction system 100 detecting that the user selected the call-to-action message 504, the interaction system 100 provides 502 a post-capture camera-style view augmentation UI 518 comprising augmented media data 508 with the selected media data 512 loaded and augmented as augmented media data 508 augmented with augmentation 510. In some examples, the call-to-action message 504 is displayed for camera roll and general memory items. Such context-aware prompting provides quick access to augment specific media data.

In some examples, the interaction system 100 triggers the call-to-action message 504 for all selected media data. In some examples, the interaction system 100 displays the call-to-action message 504 only for media data without existing augmentations.

The camera-style view augmentation UI 518 includes a back selection icon 520. In response to the interaction system 100 detecting a user selection of the back selection icon 520, the interaction system 100 returns back to the media gallery UI 528 or other entry point to the camera-style view augmentation UI 518. In some examples, the camera-style view augmentation UI 518 includes an “Add an Augmentation” prompt 522 in lieu of camera or other controls as live camera controls are not needed for previously captured media data.

In some examples, the camera-style view augmentation UI 518 further includes an augmentation carousel 514 and a selectable explorer icon 524. An initial selected augmentation 516 is pre-selected and applied to the selected media data 512 to generate the augmented media data 508 that is provided to the user via the camera-style view augmentation UI 518. In response to the interaction system 100 detecting the user swiping the augmentation carousel 514, the interaction system 100 changes the selected augmentation. In response to detecting the user tapping a capture button 526 of the client device, the interaction system 100 generates a preview of the augmented media data 508 as augmented with the currently selected augmentation. In some examples, in response to detecting a long press of the capture button 526, the interaction system 100 records a video with the currently selected augmentation.

In some examples, the camera-style view augmentation UI 518 includes a media carousel 530 used by the user to select selected media data from the user's media library. The interaction system 100 generates the media carousel 530 comprising selectable images (e.g., thumbnails and the like) of media data stored in the user's personal media library 328 (of FIG. 3B), such as in their camera roll 314 (of FIG. 3B). For example, the media carousel 530 includes thumbnail images of photos and videos from the user's camera roll 314. The interaction system 100 displays the media carousel 530 in the camera-style view augmentation UI 518. The media carousel 530 enables the user to scroll through and select specific stored media data as the selected media data 512 to augment in the augmentation UI 518. In some examples, the interaction system 100 configures the media carousel 530 to be hidden for some entry points where it is not needed.

In some examples, the camera-style view augmentation UI 518 is provided to the user as the media gallery UI 528 and the user selects selected media data 534 from the media carousel 530 and selects an augmentation from the augmentation carousel 514 from within the camera-style view augmentation UI 518.

In some examples, there is no live camera feed into the camera-style view augmentation UI 518 as it functions as a player for the selected media data. Use of such a customized camera view allows intuitive augmentation of previously captured photos and videos.

FIG. 6A is a process flow diagram depicting a machine learning and deployment process 616 and FIG. 6B is an illustration of a machine learning and deployment pipeline 646, according to some examples. The machine learning and deployment pipeline 646 may be used to generate a trained machine-learning program 618 such as, but not limited to, a facial recognition model to perform operations associated with augmenting content data.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable using one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions using the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine-learning program 618 may include multiple phases that form part of the machine learning and deployment pipeline 646, including for example the following phases illustrated in FIG. 6A:
Data collection and preprocessing 602: This phase may include acquiring and cleaning data to ensure that it is suitable for use in the machine learning model. This phase may also include removing duplicates, handling missing values, and converting data into a suitable format.
Feature engineering 604: This phase may include selecting and transforming the training data 622 to create features that are useful for predicting the target variable. Feature engineering may include (1) receiving features 624 (e.g., as structured or labeled data in supervised learning) and/or (2) identifying features 624 (e.g., unstructured or unlabeled data for unsupervised learning) in training data 622.
Model selection and training 606: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 608: This phase may include evaluating the performance of a trained model (e.g., the trained machine-learning program 618) on a separate testing dataset. This phase can help determine if the model is overfitting or underfitting and determine whether the model is suitable for deployment.
Prediction 610: This phase involves using a trained model (e.g., trained machine-learning program 618) to generate predictions on new, unseen data.
Validation, refinement or retraining 612: This phase may include updating a model using feedback generated from the prediction phase, such as new data or user feedback.
Deployment 614: This phase may include integrating the trained model (e.g., the trained machine-learning program 618) into a more extensive system or application, such as a web service, mobile app, or IoT device. This phase can involve setting up APIs, building a user interface, and ensuring that the model is scalable and can handle large volumes of data.

FIG. 6B illustrates further details of two example phases, namely a training phase 620 (e.g., part of the model selection and trainings 606) and a prediction phase 626 (part of prediction 610). Prior to the training phase 620, feature engineering 604 is used to identify features 624. This may include identifying informative, discriminating, and independent features for effectively operating the trained machine-learning program 618 in pattern recognition, classification, and regression. In some examples, the training data 622 includes labeled data, known for pre-identified features 624 and one or more outcomes. Each of the features 624 may be a variable or attribute, such as an individual measurable property of a process, article, system, or phenomenon represented by a data set (e.g., the training data 622). Features 624 may also be of different types, such as numeric features, strings, and graphs, and may include one or more of content 628, concepts 630, attributes 632, historical data 634, and/or user data 636, merely for example.

In training phase 620, the machine learning and deployment pipeline 646 uses the training data 622 to find correlations among the features 624 that affect a predicted outcome or prediction/inference data 638.

With the training data 622 and the identified features 624, the trained machine-learning program 618 is trained during the training phase 620 during machine-learning program training 640. The machine-learning program training 640 appraises values of the features 624 as they correlate to the training data 622. The result of the training is the trained machine-learning program 618 (e.g., a trained or learned model).

Further, the training phase 620 may involve machine learning, in which the training data 622 is structured (e.g., labeled during preprocessing operations). The trained machine-learning program 618 implements a neural network 642 capable of performing, for example, classification and clustering operations. In other examples, the training phase 620 may involve deep learning, in which the training data 622 is unstructured, and the trained machine-learning program 618 implements a deep neural network 642 that can perform both feature extraction and classification/clustering operations.

In some examples, a neural network 642 may be generated during the training phase 620, and implemented within the trained machine-learning program 618. The neural network 642 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 642 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 642 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 620, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 626, the trained machine-learning program 618 uses the features 624 for analyzing query data 644 to generate inferences, outcomes, or predictions, as examples of a prediction/inference data 638. For example, during prediction phase 626, the trained machine-learning program 618 generates an output. Query data 644 is provided as an input to the trained machine-learning program 618, and the trained machine-learning program 618 generates the prediction/inference data 638 as output, responsive to receipt of the query data 644.

In some examples, the trained machine-learning program 618 may be a generative AI model. Generative AI is a term that may refer to any type of artificial intelligence that can create new content from training data 622. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data using these relationships. Transformer models can handle sequential data, such as text or speech, as well as non-sequential data, such as images or code.

In generative AI examples, the output prediction/inference data 638 include predictions, translations, summaries or media data.

### Data Architecture

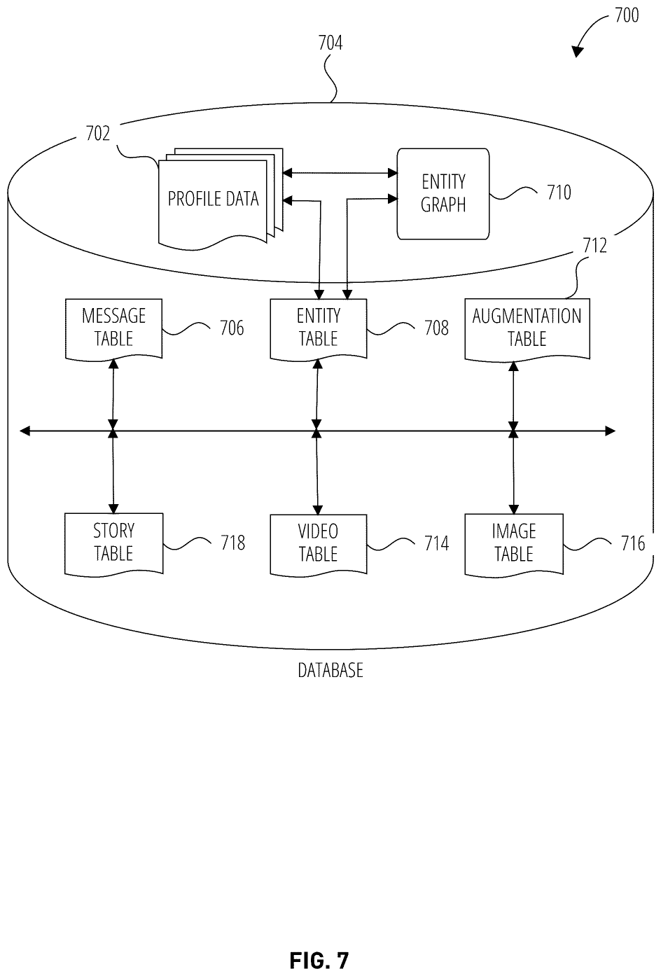

FIG. 7 is a schematic diagram illustrating data structures 700, which may be stored in the database 704 of the interaction system servers 110, according to certain examples. While the content of the database 704 is shown to comprise multiple tables, it will be appreciated that the data could be stored in other types of data structures (e.g., as an object-oriented database).

The database 704 includes message data stored within a message table 706. This message data includes, for any particular message, at least message sender data, message recipient (or receiver) data, and a payload. Further details regarding information that may be included in a message, and included within the message data stored in the message table 706, are described below with reference to FIG. 7.

An entity table 708 stores entity data, and is linked (e.g., referentially) to an entity graph 710 and profile data 702. Entities for which records are maintained within the entity table 708 may include individuals, corporate entities, organizations, objects, places, events, and so forth. Regardless of entity type, any entity regarding which the interaction system servers 110 stores data may be a recognized entity. Each entity is provided with a unique identifier, as well as an entity type identifier (not shown).

The entity graph 710 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 708. Such privacy settings may be applied to all types of relationships within the context of the interaction system 100, or may selectively be applied to only certain types of relationships.

The profile data 702 stores multiple types of profile data about a particular entity. The profile data 702 may be selectively used and presented to other users of the interaction system 100 based on privacy settings specified by a particular entity. Where the entity is an individual, the profile data 702 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 702 for the group may similarly include one or more avatar representations associated with the group, in addition to the group name, members, and various settings (e.g., notifications) for the relevant group.

The database 704 also stores augmentation data, such as overlays or filters, in an augmentation table 712. The augmentation data is associated with and applied to videos (for which data is stored in a video table 714) and images (for which data is stored in an image table 716).

Filters, in some examples, are overlays that are displayed as overlaid on an image or video during presentation to a message receiver. Filters may be of various types, including user-selected filters from a set of filters presented to a message sender by the interaction client 104 when the message sender is composing a message. Other types of filters include geolocation filters (also known as geo-filters), which may be presented to a message sender based on geographic location. For example, geolocation filters specific to a neighborhood or special location may be presented within a user interface by the interaction client 104, based on geolocation information determined by a Global Positioning System (GPS) unit of the client system 102.

Another type of filter is a data filter, which may be selectively presented to a message sender by the interaction client 104 based on other inputs or information gathered by the client system 102 during the message creation process. Examples of data filters include current temperature at a specific location, a current speed at which a message sender is traveling, battery life for a client system 102, or the current time.

Other augmentation data that may be stored within the image table 716 includes augmented reality content items (e.g., corresponding to applying augmentations or augmented reality experiences). An augmented reality content item may be a real-time special effect and sound that may be added to an image or a video.

As described above, augmentation data includes augmented reality (AR), virtual reality (VR) and mixed reality (MR) content items, overlays, image transformations, images, and modifications that may be applied to image data (e.g., videos or images). This includes real-time modifications, which modify an image as it is captured using device sensors (e.g., one or multiple cameras) of the client system 102 and then displayed on a screen of the client system 102 with the modifications. This also includes modifications to stored content, such as video clips in a collection or group that may be modified. For example, in a client system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a client system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the client system 102) and perform complex image manipulations locally on the client system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client system 102.

In some examples, a computer animation model to transform image data can be used by a system where a user may capture an image or video stream of the user (e.g., a selfie) using the client system 102 having a neural network operating as part of an interaction client 104 operating on the client system 102. The transformation system operating within the interaction client 104 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the client system 102 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 718 stores data regarding collections of messages and associated image, video, or audio data, which are compiled into a collection (e.g., a story or a gallery). The creation of a particular collection may be initiated by a particular user (e.g., each user for which a record is maintained in the entity table 708). A user may create a “personal story” in the form of a collection of content that has been created and sent/broadcast by that user. To this end, the user interface of the interaction client 104 may include an icon that is user-selectable to enable a message sender to add specific content to his or her personal story.

A collection may also constitute a “live story,” which is a collection of content from multiple users that is created manually, automatically, or using a combination of manual and automatic methodologies. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose client system 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 714 stores video data that, in some examples, is associated with messages for which records are maintained within the message table 706. Similarly, the image table 716 stores image data associated with messages for which message data is stored in the entity table 708. The entity table 708 may associate various augmentations from the augmentation table 712 with various images and videos stored in the image table 716 and the video table 714.

The databases 704 also include social network information collected by an interaction system of an interaction system. The social network information may include without limitation relationship and communication data for users of the interaction system. The social network information can be used to group two or more users and offer additional functionality of the interaction system 100. Examples of relationships include, but are not limited to, best friends relationships where two or more users are determined to be mutual best friends based on a frequency of their interactions, users who have common interests in current events, users who share an affiliation through social clubs or philanthropic organizations, and the like. Examples of communications include without limitation chats, private and public messages, exchanges of media such as images, videos, audio recordings, and the like.

### Data Communications Architecture

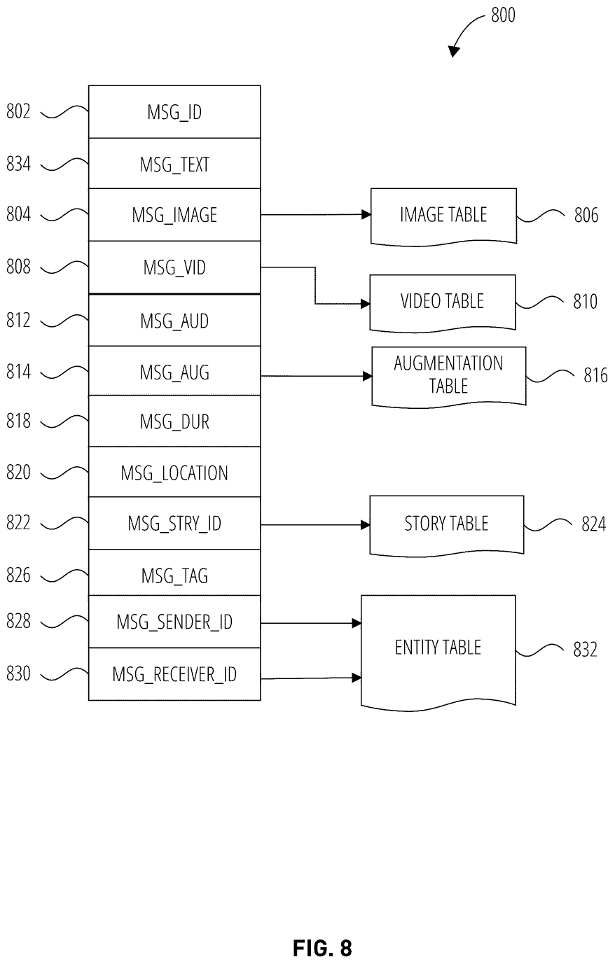

FIG. 8 is a schematic diagram illustrating a structure of a message 800, according to some examples, generated by an interaction client 104 for communication to a further interaction client 104 via the interaction servers 124. The content of a particular message 800 is used to populate the message table 706 stored within the database 704, accessible by the interaction servers 124. Similarly, the content of a message 800 is stored in memory as “in-transit” or “in-flight” data of the client system 102 or the interaction servers 124. A message 800 is shown to include the following example components:
Message identifier 802: a unique identifier that identifies the message 800.
Message text payload 834: text, to be generated by a user via a user interface of the client system 102, and that is included in the message 800.
Message image payload 804: image data, captured by a camera component of a client system 102 or retrieved from a memory component of a client system 102, and that is included in the message 800. Image data for a sent or received message 800 may be stored in the image table 806.
Message video payload 808: video data, captured by a camera component or retrieved from a memory component of the client system 102, and that is included in the message 800. Video data for a sent or received message 800 may be stored in the video table 810.
Message audio payload 812: audio data, captured by a microphone or retrieved from a memory component of the client system 102, and that is included in the message 800.
Message augmentation data 814: augmentation data (e.g., filters, stickers, or other annotations or enhancements) that represents augmentations to be applied to message image payload 804, message video payload 808, or message audio payload 812 of the message 800. Augmentation data for a sent or received message 800 may be stored in the augmentation table 816.
Message duration parameter 818: parameter value indicating, in seconds, the amount of time for which content of the message (e.g., the message image payload 804, message video payload 808, message audio payload 812) is to be presented or made accessible to a user via the interaction client 104.
Message geolocation parameter 820: geolocation data (e.g., latitudinal and longitudinal coordinates) associated with the content payload of the message. Multiple message geolocation parameter 820 values may be included in the payload, each of these parameter values being associated with respect to content items included in the content (e.g., a specific image within the message image payload 804, or a specific video in the message video payload 808).
Message story identifier 822: identifier values identifying one or more content collections (e.g., “stories” identified in the story table 824) with which a particular content item in the message image payload 804 of the message 800 is associated. For example, multiple images within the message image payload 804 may each be associated with multiple content collections using identifier values.
Message tag 826: each message 800 may be tagged with multiple tags, each of which is indicative of the subject matter of content included in the message payload. For example, where a particular image included in the message image payload 804 depicts an animal (e.g., a lion), a tag value may be included within the message tag 826 that is indicative of the relevant animal. Tag values may be generated manually, based on user input, or may be automatically generated using, for example, image recognition.
Message sender identifier 828: an identifier (e.g., a messaging system identifier, email address, or device identifier) indicative of a user of the client system 102 on which the message 800 was generated and from which the message 800 was sent.
Message receiver identifier 830: an identifier (e.g., a messaging system identifier, email address, or device identifier) indicative of a user of the client system 102 to which the message 800 is addressed.

The contents (e.g., values) of the various components of message 800 may be pointers to locations in tables within which media data values are stored. For example, an image value in the message image payload 804 may be a pointer to (or address of) a location within an image table 806. Similarly, values within the message video payload 808 may point to data stored within a video table 810, values stored within the message augmentation data 814 may point to data stored in an augmentation table 816, values stored within the message story identifier 822 may point to data stored in a story table 824, and values stored within the message sender identifier 828 and the message receiver identifier 830 may point to user records stored within an entity table 832.

### Machine Architecture

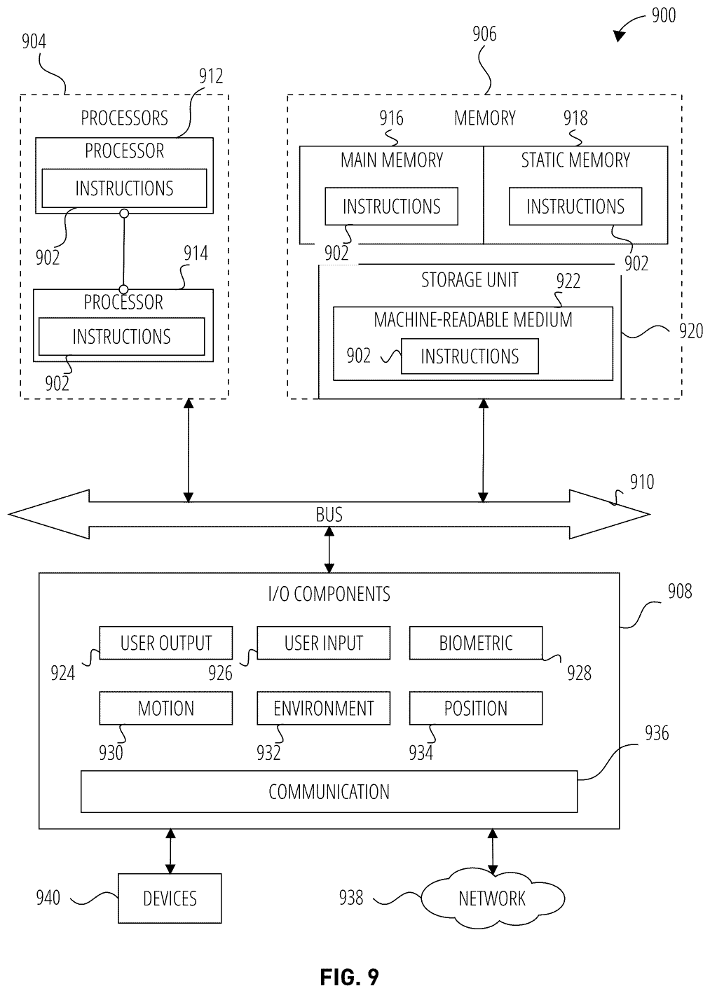

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a computing apparatus, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the client system 102 or any one of multiple server devices forming part of the interaction system servers 110. In some examples, the machine 900 may also comprise both client and server systems, with certain operations of a particular method or algorithm being performed on the server-side and with certain operations of the particular method or algorithm being performed on the client-side.

The machine 900 may include processors 904, memory 906, and input/output I/O components 908, which may be configured to communicate with each other via a bus 910. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that execute the instructions 902. The term “processor” is intended to include multi-core processors that may comprise two or more independent processors (sometimes referred to as “cores”) that may execute instructions contemporaneously. Although FIG. 9 shows multiple processors 904, the machine 900 may include a single processor with a single-core, a single processor with multiple cores (e.g., a multi-core processor), multiple processors with a single core, multiple processors with multiples cores, or any combination thereof.

The memory 906 includes a main memory 916, a static memory 918, and a storage unit 920, both accessible to the processors 904 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 930 include acceleration sensor components (e.g., accelerometer), gravitation sensor components, rotation sensor components (e.g., gyroscope). The biometric components may include a brain-machine interface (BMI) system that allows communication between the brain and an external device or machine. This is achieved by recording brain activity, translating it into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which involve surgically implanting electrodes directly into the brain.
Optogenetics BMIs, which use light to control the activity of specific nerve cells in the brain.
Functional magnetic resonance imaging (fMRI)-based BMIs, which use magnetic fields to measure blood flow in the brain, which can be used to infer brain activity.

The environmental components 932 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client system 102 may have a camera system comprising, for example, front cameras on a front surface of the client system 102 and rear cameras on a rear surface of the client system 102. The front cameras may, for example, be used to capture still images and video of a user of the client system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client system 102 may also include a 360° camera for capturing 360° photographs and videos.

Further, the camera system of the client system 102 may include dual rear cameras (e.g., a primary camera as well as a depth-sensing camera), or even triple, quad or penta rear camera configurations on the front and rear sides of the client system 102. These multiple cameras systems may include a wide camera, an ultra-wide camera, a telephoto camera, a macro camera, and a depth sensor, for example.

The position components 934 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 908 further include communication components 936 operable to couple the machine 900 to a network 938 or devices 940 via respective coupling or connections. For example, the communication components 936 may include a network interface component or another suitable device to interface with the network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the processors 904) and storage unit 920 may store one or more sets of instructions and data structures (e.g., software) embodying or used by any one or more of the methodologies or functions described herein. These instructions (e.g., the instructions 902), when executed by processors 904, cause various operations to implement the disclosed examples.

The instructions 902 may be transmitted or received over the network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### Software Architecture

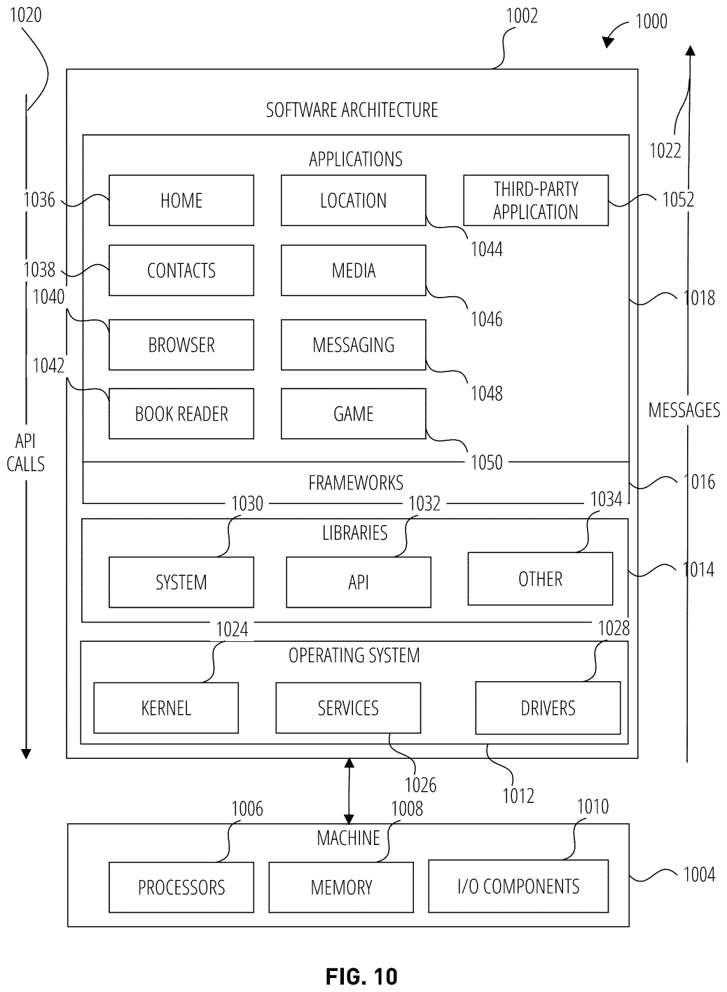

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematic functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

Further examples include:

Example 1 is a method comprising: detecting, by one or more processors, a selection of selected media data from stored media data of a first user; detecting, by the one or more processors, a type of the selection and a type of the selected media data; generating, by the one or more processors, augmented media data by applying an augmentation to the selected media data based on the type of the selection and the type of the selected media data; and providing, by the one or more processors, to a second user, the augmented media data.

In Example 2, the subject matter of Example 1 includes, wherein the type of the selection is a tap, the type of the selected media data is image data, and the augmented media data comprises image data with the augmentation applied to the selected media data.

In Example 3, the subject matter of any of Examples 1-2 includes, wherein the type of the selection is a tap, the type of the selected media data is video data, and the augmented media data comprises image data with the augmentation applied to a frame of the selected media data.

In Example 4, the subject matter of any of Examples 1-3 includes, wherein the type of the selection is a long press, the type of the selected media data is image data, the selected media data comprises data of a still image, and the augmented media data comprises video data with the augmentation applied as an animation to the still image.

In Example 5, the subject matter of any of Examples 1˜4 includes, wherein the type of the selection is a long press, the type of the selected media data is video data, and the augmented media data comprises video data of the augmentation applied as an animation to the selected media data.

In Example 6, the subject matter of any of Examples 1-5 includes, receiving, by the one or more processors, a selection of the augmentation from a carousel of available augmentations.

In Example 7, the subject matter of any of Examples 1-6 includes, recognizing, by the one or more processors, a face in the selected media data; and positioning, by the one or more processors, the augmentation on the face in the selected media data.

Example 8 is at least one machine-readable medium including instructions that, when executed by processing circuitry, cause the processing circuitry to perform operations to implement of any of Examples 1-7.

Example 9 is an apparatus comprising means to implement any of Examples 1-7.

Example 10 is a system to implement any of Examples 1-7.

### CONCLUSION

Changes and modifications may be made to the disclosed examples without departing from the scope of the present disclosure. These and other changes or modifications are intended to be included within the scope of the present disclosure.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an advertisement hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-readable storage medium” refers to both machine-storage media and transmission media. Thus, the terms include both storage devices/media and carrier waves/modulated data signals. The terms “computer-readable medium,” “machine-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine-storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory machine-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

In this disclosure and appended claims, the terms “a” or “an” are used, as is common in patent documents, to include one or more than one, independent of any other instances or usages of “at least one” or “one or more.” In this disclosure and appended claims, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the appended claims, the terms “including” and “comprising” are open-ended; that is, a system, device, article, or process that includes elements in addition to those listed after such a term in a claim is still deemed to fall within the scope of that claim.

What is claimed is:

1. A method comprising:
providing, by one or more processors, a media library User Interface (UI) displaying previously captured media data of a first user;
detecting, by the one or more processors, a selection by the first user of selected media data of the previously captured media data;
detecting, by the one or more processors, a type of the selection and a type of the selected media data;
generating, by the one or more processors, augmented media data by applying an augmentation to the selected media data based on the type of the selection and the type of the selected media data; and
providing, by the one or more processors, to a second user, the augmented media data.

2. The method of claim 1,
wherein the type of the selection is a tap, the type of the selected media data is image data, and
wherein generating the augmented media data comprises applying the augmentation to the selected media data to generate still augmented media data.

3. The method of claim 1,
wherein the type of the selection is a tap, the type of the selected media data is video data, and
wherein generating the augmented media data comprises applying the augmentation to a frame of the video data to create augmented image data.

4. The method of claim 1,
wherein the type of the selection is a long press, the type of the selected media data is image data, and
wherein generating the augmented media data comprises applying the augmentation as an animation to the image data to generate animated image data.

5. The method of claim 1,
wherein the type of the selection is a long press, the type of the selected media data is video data, and
wherein generating the augmented media data comprises compositing the augmentation as an animation with the video data to generate augmented video data.

6. The method of claim 1, further comprising:
receiving, by the one or more processors, a selection of the augmentation from a carousel of available augmentations.

7. The method of claim 1, further comprising:
recognizing, by the one or more processors, a face in the selected media data; and
positioning, by the one or more processors, the augmentation on the face in the selected media data.

8. A machine, comprising:
one or more processors; and
one or more memories storing instructions that, when executed by the one or more processors, cause the machine to perform operations comprising:
providing a media library UI displaying previously captured media data of a first user;
detecting a selection by the first user of selected media data of the previously captured media data;
detecting a type of the selection and a type of the selected media data;
generating augmented media data by applying an augmentation to the selected media data based on the type of the selection and the type of the selected media data; and
providing to a second user, the augmented media data.

9. The machine of claim 8, wherein the operations further comprise,
wherein the type of the selection is a tap, the type of the selected media data is image data, and
wherein generating the augmented media data comprises applying the augmentation to the selected media data to generate still augmented media data.

10. The machine of claim 8, wherein the operations further comprise,
wherein the type of the selection is a tap, the type of the selected media data is video data, and
wherein generating the augmented media data comprises applying the augmentation to a frame of the video data to create augmented image data.

11. The machine of claim 8, wherein the operations further comprise,
wherein the type of the selection is a long press, the type of the selected media data is image data, and
wherein generating the augmented media data comprises applying the augmentation as an animation to the image data to generate animated image data.

12. The machine of claim 8, wherein the operations further comprise,
wherein the type of the selection is a long press, the type of the selected media data is video data, and
wherein generating the augmented media data comprises compositing the augmentation as an animation with the video data to generate augmented video data.

13. The machine of claim 8, wherein the operations further comprise:
receiving a selection of the augmentation from a carousel of available augmentations.

14. The machine of claim 8, wherein the operations further comprise:
recognizing a face in the selected media data; and
positioning the augmentation on the face in the selected media data.

15. A machine-storage medium storing instructions that, when executed by one or more processors of a machine, cause the machine to perform operations comprising:
providing a media library UI displaying previously captured media data of a first user;
detecting a selection by the first user of selected media data of the previously captured media data;
detecting a type of the selection and a type of the selected media data;
generating augmented media data by applying an augmentation to the selected media data based on the type of the selection and the type of the selected media data; and
providing to a second user, the augmented media data.

16. The machine-storage medium of claim 15, wherein the operations further comprise,
wherein the type of the selection is a tap, the type of the selected media data is image data, and
wherein generating the augmented media data comprises applying the augmentation to the selected media data to generate still augmented media data.

17. The machine-storage medium of claim 15, wherein the operations further comprise,
wherein the type of the selection is a tap, the type of the selected media data is video data, and
wherein generating the augmented media data comprises applying the augmentation to a frame of the video data to create augmented image data.

18. The machine-storage medium of claim 15, wherein the operations further comprise,
wherein the type of the selection is a long press, the type of the selected media data is image data, and
wherein generating the augmented media data comprises applying the augmentation as an animation to the image data to generate animated image data.

19. The machine-storage medium of claim 15, wherein the operations further comprise,
wherein the type of the selection is a long press, the type of the selected media data is video data, and
wherein generating the augmented media data comprises compositing the augmentation as an animation with the video data to generate augmented video data.

20. The machine-storage medium of claim 15, wherein the operations further comprise:
recognizing a face in the selected media data; and
positioning the augmentation on the face in the selected media data.
